(19) United States
(12) Patent Application Publication
(10) Pub. No.: US 2015/0254692 A1
(43) Pub. Date: Sep. 10, 2015

(54) METHOD AND APPARATUS FOR SOCIAL NETWORKING SERVICE STRATEGY BASED ON SPREAD SIMULATION

(71) Applicant: Nokia Technologies Oy, Espoo (FI)

(72) Inventors: Tong Xu, Beijing (CN); Huanhuan Cao, Beijing (CN); Jilei Tian, Beijing (CN)

(21) Appl. No.: 14/432,552

(22) PCT Filed: Oct. 8, 2012
(86) PCT No.: PCT/CN2012/082576

§ 371 Date: Mar. 31, 2015

(51) Int. Cl. G06Q 30/02; H04L 29/06

(52) U.S. Cl. CPC G06Q 30/0204; H04L 65/403

(57) ABSTRACT

An approach is provided for using spread simulations to enhance media distribution. The distribution processer determines one or more seed user groups made of one or more seed users. Next, the distribution processor processes and/or facilitates a processing of one or more spread process simulations with the one or more seed user groups. Then, the distribution processor causes, at least in part, media distribution based, at least in part, on the one or more spread process simulations.

### BACKGROUND

Service providers and device manufacturers (e.g., wireless, cellular, etc.) are continually challenged to deliver value and convenience to consumers by, for example, providing compelling network services. One area of interest has been the development of distributing media through social networks. For instance, social networks are increasingly recognized as an important resource for influencing adoption of products and services. With social networks, “word-of-mouth” communication (WOM) has a significant effect on consumer purchasing behavior since consumers are found to associate WOM with lower perceived risk and service purchase decisions. However, traditional “broadcasting” of media, especially advertisements, often lacks specificity for the consumers receiving the advertisements. As a result, service providers face significant challenges in developing marketing strategies to distribute media relevant to consumers and leveraging WOM through social networks, especially for both online and offline customer networks.

### SOME EXAMPLE EMBODIMENTS

Therefore, there is a need for an approach for using spread simulations to enhance media distribution.

According to one embodiment, a method comprises determining one or more seed user groups made of one or more seed users. The method also comprises processing and/or facilitating a processing of one or more spread simulations with the one or more seed user groups. The method further comprises causing, at least in part, media distribution based, at least in part, on the one or more spread process simulations.

According to another embodiment, an apparatus comprises at least one processor, and at least one memory including computer program code for one or more computer programs, the at least one memory and the computer program code configured to, with the at least one processor, cause, at least in part, the apparatus to determine one or more seed user groups made of one or more seed users. The apparatus is also caused to process and/or facilitate a processing of one or more spread simulations with the one or more seed user groups. The apparatus is further caused to cause, at least in part, media distribution based, at least in part, on the one or more spread process simulations.

According to another embodiment, a computer-readable storage medium carries one or more sequences of one or more instructions which, when executed by one or more processors, cause, at least in part, an apparatus to determine one or more seed user groups made of one or more seed users. The apparatus is also caused to process and/or facilitate a processing of one or more spread simulations with the one or more seed user groups. The apparatus is further caused to cause, at least in part, media distribution based, at least in part, on the one or more spread process simulations.

According to another embodiment, an apparatus comprises means for determining one or more seed user groups made of one or more seed users. The apparatus also comprises means for processing and/or facilitating a processing of one or more spread simulations with the one or more seed user groups. The apparatus further comprises means for causing, at least in part, media distribution based, at least in part, on the one or more spread process simulations.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20 and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of using spread simulations to enhance media distribution, according to one embodiment;

FIG. 2 is a diagram of the components of a distribution processor that uses spread simulations to determines media to distribute, according to one embodiment;

FIG. 3A-3C are diagrams of the components of platforms operating in the distribution processor, according to one embodiment;

FIG. 4 is a flowchart of a process for distributing media based on spread simulations, according to one embodiment;

FIG. 5 is a flowchart of a process for determining seed user groups, according to one embodiment;

FIG. 6 is a flowchart of a process for conducting spread simulations, according to one embodiment;

FIG. 7 is a flowchart of a process for inferring potential adopters, according to one embodiment;

FIG. 8 is a flowchart of a process for monitoring and regulating the media distribution, according to one embodiment;

FIGS. 9A-9B are illustrations of the processes of FIG. 4, according to various embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for using spread simulations to enhance media distribution are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

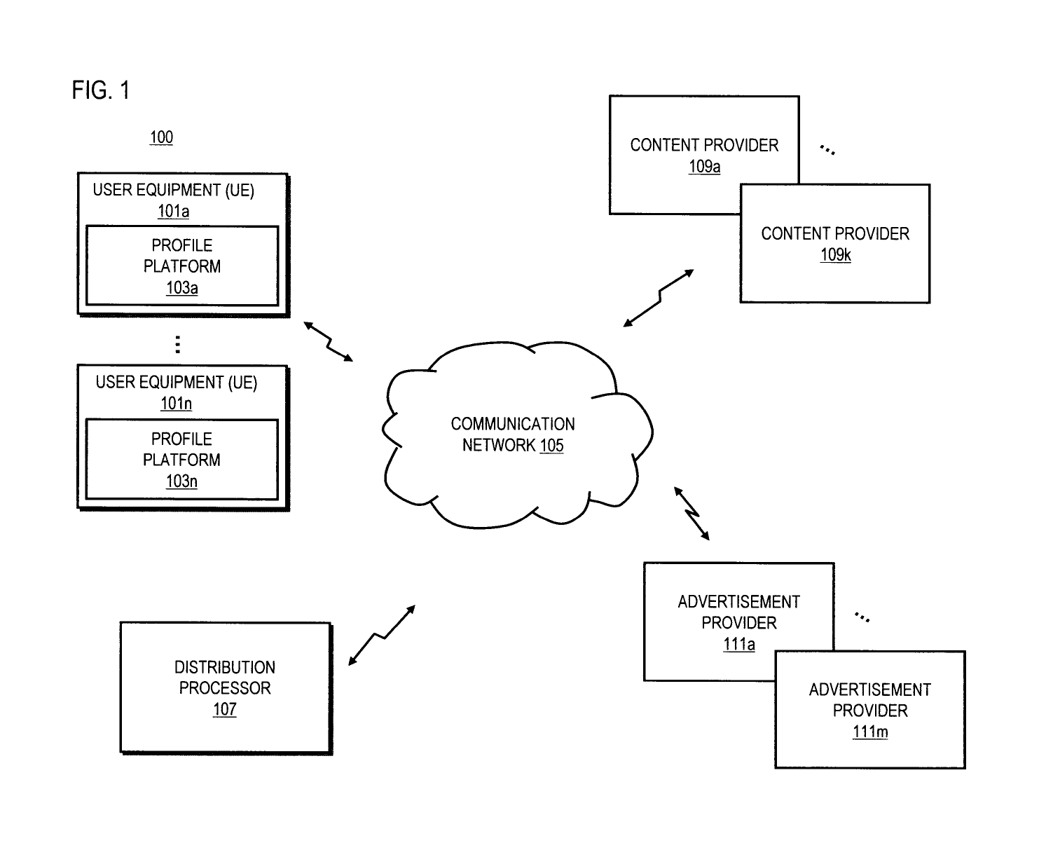

FIG. 1 is a diagram of a system capable of distributing media based on spread simulations, according to one embodiment. The system presents a method of quantified viral marketing analysis that may permit 1) maximum content item spread (through a social network) and 2) monitor and update the spread, for both online and offline scenarios. As noted above, service providers and device manufacturers are increasingly recognizing the power of social networks, and especially “word-of-mouth” (WOM) communication amongst consumers within a network. For example, consumers may share their behavior regarding purchasing products, or share their opinions on certain products. This sharing is shown to have a significant influence on consumer purchasing behavior of users associated with the sharing consumers since consumers are found to replicate purchase decisions of their connections within a social network.

Research has shown such behavior to be true for both online and offline consumer networks. Although online social network services develop rapidly, traditional offline social networks are also powerful influences on consumer purchasing behavior. In other words, either network of relationships is highly useful for marketing or distributing content items, especially as social spread through peer-to-peer (p2p) communication techniques (including Near Field Communication (NFC) or Bluetooth) grows. Currently, online social networks receive traditional “broadcasting” advertisements, where the advertisements are the same for all users. Alternately, the advertisements are often distributed using “personalized recommendations” techniques. With “broadcasting,” the advertisements are often ignored because users frequently find them irrelevant. For the “personalized recommendations,” actual sharing is low because users are operating without the support or reinforcement of feedback from trusted social network connections. For instance, people may consider their friends (within a social network) or public figures as a “filter,” where trending responses of the friends and figures may influence peoples' response to the advertisements. Thus, despite being more expensive than “broadcasting,” “personalized recommendation” advertising techniques still lack the potential success of using social network experience associated with a particular advertisement for determining an advertising strategy.

Similarly in the offline context, advertisement strategies are limited by not using social network experience. For example, ordinary offline advertisements show no clear feedback or controls regarding the success of the advertisements. Also, there is no network structure or user profile-oriented strategy to ensure the success of an advertisement on the side of a bus. Moreover, offline advertising may eliminate an entire population that lacks access to the internet.

Meanwhile, simulations of social spread processes are being developed where proliferation of products, media, content items, or a combination thereof through a set of users (or nodes) can be modeled. The simulations include means to maximize spread range, meaning the extent, speed, and efficiency of the spread. For example, path length predictions or Stead State Spread (SSS) models are useful for simulating spread process of items through a network, as provided by, for instance, Yu Yang, Enhong Chen, Qi Liu, Biao Xiang, Tong Xu and Shafqat Ali Shad in “On Approximation of Real-World Influence Spread,” ECML-PKDD 2012, Bristol, UK, LNCS 7524, 2012, pp. 548-564. However, advertising strategy has yet to take advantage of the spread simulations to improve marketing.

Additionally, current advertising strategies lack the ability to control and/or regulate the spread process after launching the advertisements for proliferation. As such, leveraging WOM communication in both online and offline social networks and monitoring the launch through the social networks is necessary to developing an effective advertising strategy.

To address this problem, a system 100 of FIG. 1 introduces the capability to use spread simulations to enhance media distribution. In one embodiment, the server may distribute media according to predicted, simulated spread of the given media item. In one embodiment, the spread effect may improve media distribution by: (1) predicting a given media item's spread within a social networking service by simulating the spread of the media item amongst various groups of users, (2) estimating interested users based on the simulations, (3) analyzing user properties of the interested users to infer potential purchasing interests, (4) combining media items with advertisements associated with the potential purchasing interests, and delivering the combined content to users, and (5) monitoring the actual spread process via selected key users to update the distribution if the spread does not match expectations.

In one embodiment, the system 100 may perform a social networking service advertising strategy based on simulating spread effect of a given content item through one or more social networks. For example, the system 100 may run one or more spread simulations for a content item through one or more seed user groups to determine estimates of best case scenarios where users may be interested in the content item, analyses the profiles of the interested users, and distribute content items according to the profiles. In one embodiment, the system 100 may further include monitoring of the actual spread process after launch of the content item so that system 100 may make alterations to the groups where the content item is distributed if the spread does not resemble the expectations from the simulation. In one embodiment, “seed users” refers to initial sharers of the given content item. In other words, these are the users that act as the “information source” in the social network. These are the users that may ultimately launch the content item through a social network.

In one embodiment, such a strategy includes simulating spread through different seed user groups. For instance, the system 100 may determine multiple user groups based on user properties. For example, each user may be associated with two properties: user profile and user preference. User profile may include descriptive personal characteristics of users, including gender, age, profession, income, alma mater, etc. User preference may include user interest in particular media topics. For example, user preference for music may include pop music, classical, country, etc. User preference for movies may include drama, comedy, horror, romance, musical, etc. Additionally, groups may be based off of external parameters, including time of day, activity, content item, or a combination thereof. Furthermore, the groups may be based, at least in part, on network settings, including online, offline, or a combination thereof. In other words, grouping of seed user groups may include single and/or multiple criteria. User properties, external parameters, network settings, etc. are simply exemplary criteria for grouping of various users in one or more social networks.

In one embodiment, various seed user groups present different spread ranges. Different spread ranges may mean different levels of proliferation of content items through a social network. One such instance may include one seed user sharing a media item with five contacts in a social network, versus a second seed user sharing a media item with only two contacts in the network in a simulation. Here, the system 100 may then focus on the first seed user (over the second seed user) for actual content item distribution. Different spread ranges may also include the length of time taken for content items to spread through a social network. For example, two seed users may both share a media item with five contacts, each. However, the first seed user make take two days to share a media item with five contacts, whereas the second seed user takes five minutes. Here, the system 100 may then focus on the second seed user for distributing the media. In a further embodiment, selection of seed users and seed user groups may include criteria based on rules associated with the content items. For instance, system 100 may associate higher-priced content items with a larger spread range.

In running the spread simulations in one embodiment, the system 100 may aim to determine social media (or content item) sharing maximization (as described above), bind advertisements to content items that are users are most likely to respond to, and regulate the actual spread process after launching the media through the selected user group. In one embodiment, the system 100 may use the simulation to estimate the group where users may be interested in the content item under the impact of their associations in the social network. This may be one instances of a maximum result after conducting the spread simulation for a given content item.

In one embodiment, the system 100 may then analyses the profiles of the interested users to determine content items that suit the profiles of the users. For example, the system 100 may infer potential purchasing interests of the users based on the user profiles and determine advertisement content items accordingly. In one embodiment, the system 100 may combine the content items with other content items according to the profiles of the interested users and deliver it to selected seed user groups. For example, the other content items may include advertisements where the system 100 binds advertisements to content items delivered to the seed users.

In one embodiment, the system 100 may further ensure the quality of the distribution by monitoring some key (kernel) users and updating the seed users and seed user groups if the spread does not resemble the spread process simulation. For example, the monitoring could be real-time monitoring of the actual spread. With the many users (representing nodes) in a social network, monitoring all the users for sharing may be unrealistic. Additionally, since social sharing does not follow an exact timing, distinguishing whether sharing may still occur for a certain user may be difficult for system 100. For example, rather than broadcasts where content items may be distributed at known, pre-set times, sharing through a social network sharing may provide less advance notice as to how a given content item may spread through a social network. In one embodiment, the system 100 may respond to the issue of monitoring the spread through the entire social network by selecting only kernel users to monitor. In one instance, such monitoring may take place by identifying a length of time, where, if the user is not activated by the end of the length of time, system 100 may seek to update the seed users and/or seed user group. “Activation” may, for a scenario, stand for a user sharing a content item. For example, system 100 may identify the length of time as one day for a given content item. If, after a day, the monitored kernel user has not yet shared the content item, the system 100 recognizes that the kernel user is not activated and the system 100 may then respond by revaluating and adding new seed users.

Another instance where monitoring may lead to changes in the seed users may include an unexpected user being activated. For this, the system 100 may re-evaluate the profiles of the interested users and make adjustments to content items accordingly. For an offline scenario, monitoring may reveal implicit social links. This, like the unexpected user activation, may cause the system 100 to update user property analysis and content item selections. As such, seed user groups may be predefined, dynamic, or a combination thereof.

As shown in FIG. 1, the system 100 comprises a user equipment (UE) 101 (or UEs 101a-101n) having connectivity to profile platforms 103 (or profile platforms 103a-103n), distribution processor 107, content providers 109 (or content providers 109a-109k), and advertisement providers (or advertisement providers 111a-111m) via a communication network 105. The UEs 101 may include or have access to a profile platform 103 (or profile platform 103a-103n) to enable the UEs 101 to interact with the distribution processor 107, one or more content providers 109, one or more advertisement providers 111, and communication network 105.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the system 100 may include a server and many clients (peers). In system 100, for instance, the distribution processor 107 may represent the server and the UEs 101 may represent the clients. In some embodiments, each of the UEs 101 may communicate with the distribution processor 107 through communication network 105, which may include offline means (e.g., short message service (SMS), General Packet Radio Service (GPRS), etc.). Additionally, or alternatively, the UEs 101 may communicate with each other through communication network 105, which may include offline means (e.g. Bluetooth).

In one embodiment, all UEs 101 may include two properties associated with users: user profiles and user preference. In one embodiment, profile platforms 103 may have access to profiles and preferences associated with respective UEs 101. User profiles may include basic information about a user associated with one or more UEs 101a-101n, such as, gender, age, profession, income, language, etc. User profiles may be generated in a variety of ways, including directly prompting users to provide information, obtaining user context information, or some combination thereof. User preference may include interest on a certain media topic, including pop music, classical, country music, etc.

In one embodiment, the distribution processor 107 may group the users in terms of the user properties given by the profile platforms 103 and determine the potential for distributing media amongst the groups based on performing social spread simulation with the various groups. Such groups are deemed “seed user groups.” In comparing the spread of the media in the seed user groups, the distribution processor 107 may extract the users and user groups with the highest potential of adopting or sharing the media, and perform further analysis of these users to select adequate media for distribution to the users.

Meanwhile, content providers 109 may upload content items (and/or metadata pertaining to the content items) to the distribution processor 107 (e.g., with advertisements already embedded in the content items, without the advertisements embedded in the content items, etc.). In one scenario, clients may download songs (e.g., uploaded by musicians) directly from the server and/or from other clients. Advertisement providers 111 may also upload their advertisements (and/or metadata pertaining to the advertisements) to the distribution processor 107. The distribution processor 107 may then process the input from UEs 101, content providers 109, and advertisement providers 111 to output content item-advertisement pairings. In one embodiment, UEs 101 provide associated user profile information, content providers 109 submit content item distribution information, and advertisement providers 111 give target audience specifications to the distribution processor 107. The distribution processor 107 may then create, at least in part, content item-advertisement pairings with this information.

In some embodiments, an advertisement may be embedded in the content item as metadata, where UEs 101 may, for instance, require an application to interpret the metadata. In other embodiments, an advertisement may be of the same media as the content item, so that a separate application would not be necessary to interpret the advertisement. That is, the application utilized to process the content item may also process the advertisement.

In one scenario, an advertisement may be a picture, while a content item may be a song. A UE 101 may, for instance, display the advertisement picture on the user interface of the UE 101 while the song is playing. In another scenario, an advertisement may include an overlay on a content item, such as a picture overlay on a video content item, for instance. In yet another possible scenario, the advertisement may be of the same media as the content item. In this case, the UE 101 may play a paired advertisement preceding the downloaded content item. It is noted that, in certain embodiments, the system 100 may pair one or more advertisements to one or more content items regardless of whether the content item was previously paired with an advertisement.

For example, there may be a content item-advertisement relationship where one content item may embed, at most, one advertisement, as determined by distribution processor 107. To update the pairing relationships of content items and advertisements, the distribution processor 107 may, for instance, embed an advertisement in a content item previously without an embedded advertisement, remove an embedded advertisement from a content item where it was previously embedded, and/or change the advertisement embedded in a content item. As such, advertisements may stay current and the advertisement service (such as the advertisement providers 111) may continue to make money as new advertisements occupy advertising slots. In addition, updating the advertisement embedded in a content item may permit the system 100 to gather more input on the content item-advertisement relationship based on the content item distribution characteristics, thus providing the system with increasingly optimized pairings of advertisements to content items. Therefore, updates of the content item-advertisement relationship may occur when a new advertisement arrives, an old advertisement is expiring, when a significant amount of new data on content distribution characteristics have been gathered, etc.

By way of example, the UE 101 a-n, profile platforms 103a-103n, distribution processor 107, content providers 109a-109k, and advertisement providers 111a-111m communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

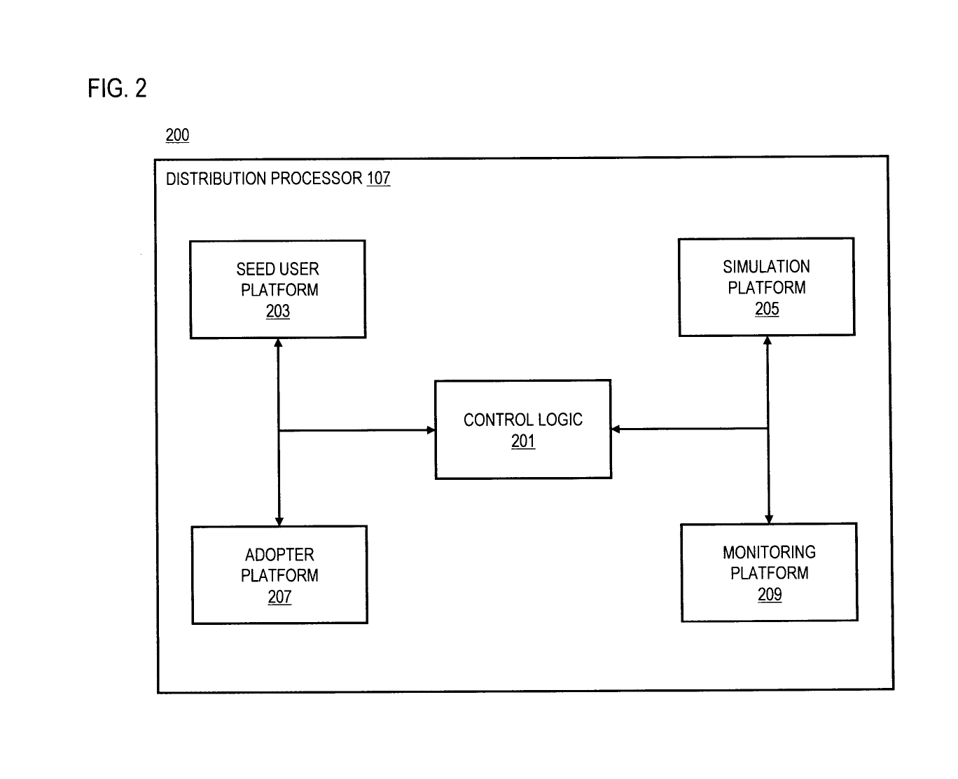

FIG. 2 is a diagram of the components of the distribution processor 107, according to one embodiment. By way of example, the distribution processor 107 includes one or more components for providing spread simulations to enhance media distribution. It is contemplated that the functions of these components may be combined in one or more components or performed by other components of equivalent functionality. In this embodiment, the distribution processor 107 includes a seed user platform 203, simulation platform 205, adopter platform 207, and monitoring platform 209. The control logic 201 may, for instance, receive information from the seed user platform 203, the simulation platform 205, the adopter platform 207, and the monitoring platform 209.

In one embodiment, the seed user platform 203 may determine one or more seed user groups made of one or more seed users. To do so, the seed user platform 203 may receive, from UEs 101, various seed users and seed users associated with the various seed users. Having identified seed users, the seed user platform 203 may access user properties provided by profile platforms 103. The properties may include user profiles and preferences, including personal characteristics of users and/or user interest levels on various topics. In one embodiment, the seed user platform 203 may then group the seed users into one or more seed user groups based on similarities in user profiles and preferences. For example, the seed user platform 203 may determine one or more seed user groups according to undergraduate school affiliations noted in user profiles. In another example, the seed user platform 203 may form one or more seed user groups based on musical tastes as shown from bands and musical genres noted by user preference.

In another embodiment, the seed user platform 203 may determine one or more seed user groups associated with one or more external parameters, including time of day, activity, content item, or a combination thereof. For instance, one or more seed user groups may be defined by seed users interacting with media at a certain time of day. In one scenario, users that access media items mostly in the evening are likely working professionals. The seed user platform 203 may infer this commonality amongst the users and determine a seed user grouping based on users that access media items mostly in the evening. In one embodiment, the seed user platform 203 may also determine the one or more seed groups based on network settings, where the network settings may include online, offline, or a combination thereof.

In a further embodiment, the seed user platform 203 may update and/or continually generate more seed user groups. For instance, the seed user platform 203 may detect changes to user properties as given by the profile platforms 103, and adjust seed user placement in seed user groups accordingly. In another example, the seed user platform 203 may incorporate more and more UEs 101 by way of receiving additional associated seed users, for instance via by association within one or more social networks. The seed user platform 203 may respond to changes in one or more associations between UEs 101 to determine new seed user groups.

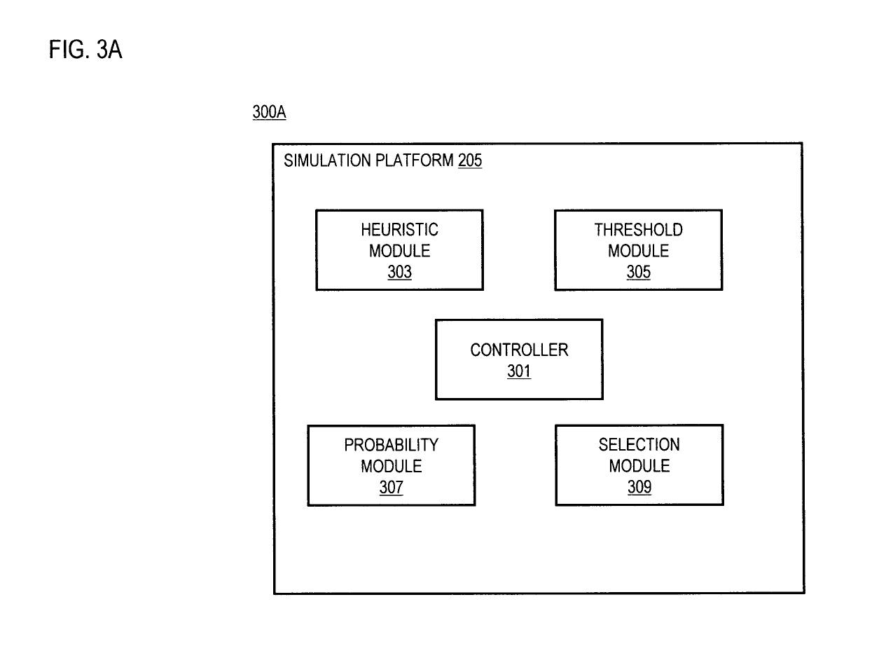

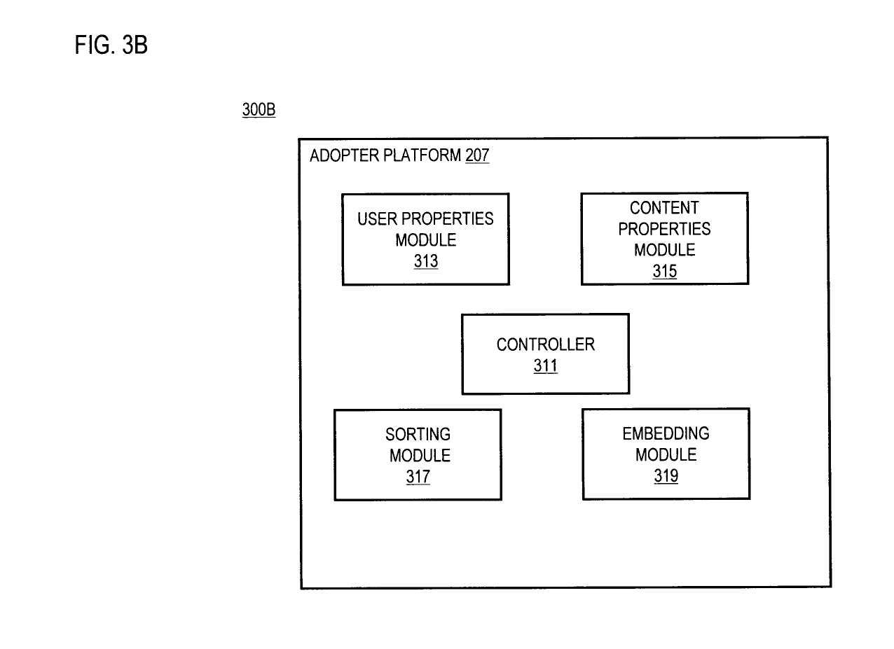

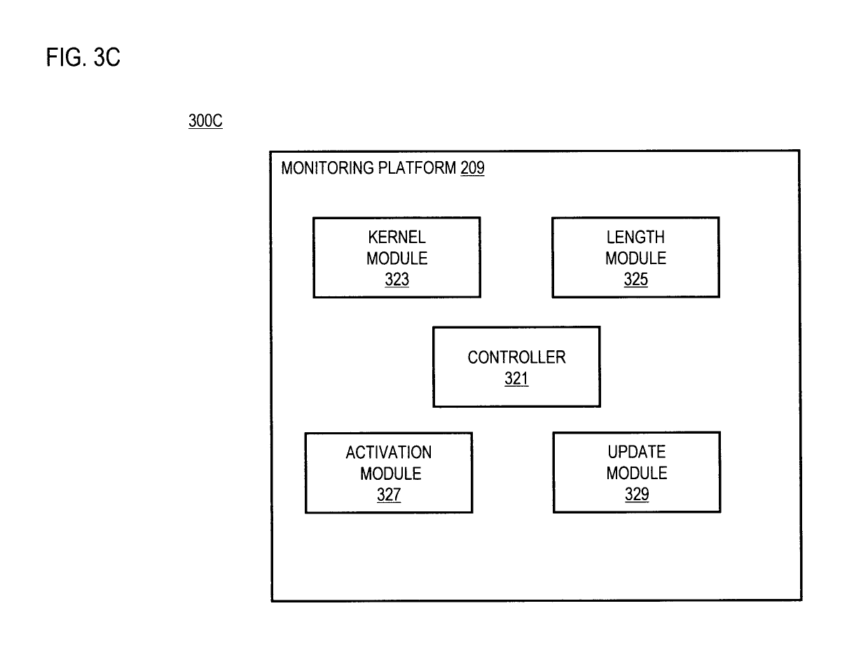

FIG. 3A is a diagram of the components of the simulation platform 205, according to one embodiment. By way of example, the simulation platform 205 includes one or more components for determining maximum spread via one or more spread simulations. It is contemplated that the functions of these components may be combined in one or more components or performed by other components of equivalent functionality. In this embodiment, the simulation platform 205 includes a controller 301, heuristic module 303, threshold module 305, probability module 307, and selection module 309. The controller 301 may, for instance, receive information from the seed user platform 203, the adopter platform 207, and the monitoring platform 209. In one embodiment, the controller 301 may work with the heuristic module 303 to run various social spread simulation models through the one or more seed user groups provided by the seed user platform 203.

By way of example, various social spread simulations are possible. In one embodiment, the controller 301 and heuristic module 303 may compute activated probability between users. Activating probability may include the probability that users to interact with content items, or that a given user interacts with a given content item. In one embodiment, the probability may include the receipt of the content item. In a further embodiment, the probability may include, not only receipt or viewing of a given content item, but that the user shares and/or transfers the content item (for example, with other members of a social network). In one embodiment, the controller 301 and heuristic module 303 may directly sum user preference and activation probability. The controller 301 may then associate the patterns presented by this analysis with potential adopter trends.

As stated before, activating probability may include the probability that a user will share a given content item with associated users or users within the same seed user group. Such probability may be known as, “edge weight.” Calculating edge weight to determine activating probability may include considering many factors, including GPS information or distance between users. For instance, if users are closer in proximity (like in an offline scenario), the users may be more likely to influence one another than users that are known to be very far from each other. One such scenario may involve a school or neighborhood. Users that are part of the same school district may be more likely to influence on another, than users that are known to be in completely different countries.

In one embodiment, the weights may be computed based on item topics and user preference (for example based on similarity of user properties acquired from profile platforms 103). Thus, different items translate into different spread probabilities and results per seed user group. For instance, between online and offline social network seed user groups where an item includes “difference of accessibility” for the offline scenario, a seed user group may include only users who can surf the Internet easily offline. These users may include those who may participate in offline browsing.

In one embodiment, the controller 301 and heuristic module 303 may simulate spread process among different seed user groups by including matrix-based social spread simulation. As previously discussed, matrix-based social spread simulation is just one example approach that the heuristic module 303 may employ. In one embodiment, each user may represent a node within the social spread, where node “activation” refers to user device sharing and/or transferring of a given content item. For instance, the controller 301 and heuristic module 303 may determine that a node influences neighboring nodes with a probability of p(u, v), the weight of an edge. This probability may be known as the “transition probability” of activated status between the two nodes, or content item transfer between the two notes. The controller 301 and heuristic module 303 may then link the probability adjacent matrix of a social network structure with a probability transition matrix in Random Walk methods, in one embodiment. For example, one simulation of social spread in the Random Walk model may include the iterative formula in matrix form like:

P′=(M^{T})′P′+(M^{T}B)′

Here in the N-dimensional (where N presents the amount of nodes), vector P presents activated probability of each node such that the N×N-dimensional matrix M presents the probability adjacent matrix, while N-dimensional vector B presents the initial status of each node. For instance, if node i is seed user bᵢ, the i-th element of vector B will be 1, otherwise it will be 0. The adjacent matrix M may be sparse since one node generally connects with only a few neighboring nodes. In one embodiment, some form of sparse matrix storage may be used to save memory.

Random Walk methods may be one exemplary simulation of spread process by taking a basic assumption of social influence, where activation of nodes in each step involves two factors: 1) influence from neighboring nodes and 2) status of neighbors in the last step (where only activated neighbors may influence other nodes). Furthermore, influence from different sources may be independent and each node can be activated only once. For example, assuming probability p and independence between activation of each node N, the probability that all the nodes N will be activated is a probability of Π_{N}(1−p). This translates into meaning that the more nodes, the more likely that activation will occur because probability of activation for the set of nodes N may be 1−Π_{N}(1−p). For each node though, the influence probability may take into account the node's own activating probability and the relationship between the node and other nodes. This can be modeled according to:

pᵥ(t)=1−Π_{uεN(v)}(1−pᵤᵥ*pᵤ(t−1))

Here, pᵥ(t) may be the activating probability (or edge weight) of point v in step t, where pᵤᵥ is the influence probability from node u (a neighbor of v) to node v.

In one embodiment, mutual influence probability between nodes may be 1% or lower than 1% so that the controller 301 and heuristic module 303 may take pᵤᵥ<<1 and approximate the above formula as:

$$\begin{matrix}{p}_{v} ( t ) = 1 - ( 1 - {\sum }_{u ∈ N ( v )} {p}_{uv} * {p}_{u} ( t - 1 ) ) \\ = {\sum }_{u ∈ N ( v )} {p}_{uv} * {p}_{u} ( t - 1 ) ,\end{matrix}$$

(This is because if, for example, probabilities for nodes a and b are far less than 1% (as in, a, b, <<1), (1−a)(1−b) may be approximated as 1−(a+b), permitting aᵢ<<1, Π(1−aᵢ) to be approximated with 1−Σaᵢ. Then, the formula is iterative and, as transformed from the probability adjacent matrix previously discussed, resembles a Random Walk probability transition matrix. Thus, Random Walk may be an appropriate model for some spread process simulations.

For example, Random walk may approximate a spread process where conditions suit:

vεV,Σ_{uεN(v)}pᵤᵥ<1

Taking into account regularization and that calculated mutual influence does not preclude individual users from not following the influence, estimating pᵤᵥ<1 may be realistic in one or more spread process simulations. As such, Random Walk is one possible model for the controller 301 and heuristic module 303 to use.

In one embodiment, the controller 301 and threshold module 305 may determine threshold activating probabilities for the various users and content items. Such activating probabilities may be based on historic spreads, average activating probabilities, idealized activating probabilities, or a combination thereof. For instance, a popular musician may assign a high threshold activating probability for a spread simulation of the musician's new song because the musician may expect that sharing of the song is likely. A new artist, however, may tolerate a much lower threshold because fewer shares are expected.

In one embodiment, the controller 301 and probability module 307 may calculate the vector P, the activation probability of each node. In one embodiment, the probability module 307 may transform the formula of the heuristic module 303 as a linear equations problem, for instance:

[I−(M^{T})′]P′=(M^{T}B)′

Here, I may be the identity matrix. In the case of linear equation problems, an iterative method could be used, including the Gauss-Seidel iteration method or Jacobi iteration method. Since the condition of the matrix that the sum of the absolute value of elements in each line (except elements in the diagonal) in M is less than 1 (i.e. the sum of each line is less than the element in the diagonal), the convergence property of iteration is ensured. For large scale social networks where such equations may involve the curse of dimensionality (difficulty caused by high dimensional data), parallel computing techniques could improve efficiency. The parallel computing techniques could ensure higher speed within a certain range (taking into account the scale of a social network, mutual communication for data updating needed, or a combination thereof).

In a further embodiment, to control irrational mutual influence, the controller 301 and probability module 307 may limit the iteration step of each of the nodes. Here, a “step” may refer to the nodes present in a path for a given content item to be shared between two nodes. For example, if a content item is directly shared between node i and node ii, one “step” may be present. If, however, a content item is moves from node i to node iii, to node iv before it is shared with node ii, the content item took four steps before reaching node ii from node i.

In one instance, the active probability may be meaningless once the probability module 307 determines that a node is activated at all because a node will not be activated more. For such an instance, the controller 301 may stop the iteration of the active probability, even if neighboring nodes are influenced by it. The controller 301 may employ multiple methods to determine the adequate step to stop the iteration are possible. For example, the Maximum Influence Path (MIP) approach is appropriate since it represents a theoretical track to activate one node with the highest probability. Another possible approach is the Shortest Path approach for showing the shortest step necessary to activate one node. These are just some exemplary methods to finding the step at which to limit iteration.

In an even further embodiment, the controller 301 may select one kind of “path length” where all the Step(v) of points are calculated, where node v is set to stop its iteration after Step(v) steps. This means after Step(v), p(v) will not change, despite its influence on other nodes. This approach may limit structural nonsense from irrational mutual influence. Since social influence process is a random process, any “path length” rule with a stable constraint may not be realistic. To include some fluctuation, the threshold module 305 may, for instance, define the threshold as Step(v)+−t, where t is a small integer. As previously noted, this approach is only one example out of many possible simulation models that controller 301 may use.

After determining threshold activating probabilities and activating probabilities of seed users, the controller 301 and selection module 309 may determine one or more seed users and one or more seed user groups with activating probabilities exceeding the thresholds. In one embodiment, the controller 301 and selection module 309 may organize the seed users, for example, according to greatest to least activating probabilities. In another embodiment, the controller 301 and selection module 309 may simply identify seed users with activating probabilities exceeding the thresholds. The controller 301 and heuristic module 303 may simulate the spread from various user nodes to select seed users to send the media item. In one embodiment, the seed users selected may be user nodes that show the most likelihood for sharing the content items.

FIG. 3B is a diagram of the components of the adopter platform 207, according to one embodiment. By way of example, the adopter platform 207 includes one or more components for determining content items for distribution to the seed users and seed user groups determined by the simulation platform 205. It is contemplated that the functions of these components may be combined in one or more components or performed by other components of equivalent functionality. In this embodiment, the adopter platform 207 includes a controller 311, user properties module 313, content properties module 315, sorting module 317, and embedding module 319. The controller 311 may, for instance, receive information from the seed user platform 203, the simulation platform 205, and the monitoring platform 209. In one embodiment, the controller 311 may work with the user properties module 313 to determine user properties (including user profile and user preference information potentially provided by profile platforms 103) for the seed users yielded by the simulation platform 205. As previously discussed, user properties associated with users include profile and/or preference information. For instance, controller 311 and user properties module 313 may determine one or more seed users from simulation platform 205 to have the profile information of attending a university known for a particular sports team and preference information of liking sports.

In one embodiment, the controller 311 and content properties module 315 may, in turn, determine properties associated with various content items, as provided by content providers 109, advertisement providers 111, or a combination thereof. For instance, content providers 109 and advertisement providers 111 may store, access, and/or provide content items along with content item properties corresponding to user properties. In one embodiment, the controller 311 and content properties module 315 may extract the content item properties associated with content items. For example, an advertisement content item may include content item properties describing the content item. For instance, an athletic shoe commercial content item showing a well-known basketball player may be associated with properties including, “shoes”, “basketball”, basketball teams associated with the athlete, or a combination thereof.

Then, the controller 311 and sorting module 317 may sort the seed user properties against content item properties to select one or more content items for media distribution based on the seed user properties. For example, the controller 311 and sorting module 317 may select content items with properties that resemble or are associated with properties of the determined one or more seed users. One such scenario may include the controller 311 and sorting module 317 may select a sports beverage commercial for one or more seed users having properties that indicate a strong affinity to sports. In a further embodiment, the controller 311 and sorting module 317 may further cause, at least in part, an association between the selected one or more content items with one or more other content items. In one embodiment, the one or more content items may include advertisements. For example, the controller 311 and embedding module 319 may select a television show as a content item for distribution, but the controller 311 and embedding module 319 may also select the television show content item and an advertisement with properties matching the television show and the analyzed seed user properties to distribute to the seed users.

FIG. 3C is a diagram of the components of the monitoring platform 209, according to one embodiment. After media distribution, the spread process is no longer controllable. However, in one embodiment, system 100 and the distribution processor 107 may include the monitoring platform 209 to define when and how to monitor the spread process to ensure the quality of the distribution and address issues after launch. In one embodiment, the system 100 could extract the first few sharing steps. However, since many nodes may exist in a social network, following spread may become difficult as more and more users are activated. In another embodiment, the system 100 may monitor spread by monitoring key nodes, or kernel nodes. Monitoring the kernel nodes is then taken as a representation of spread throughout the social network. In one embodiment, if the kernel nodes are not activated within a certain threshold, the monitoring platform 209 may initiate changes to the seed users and/or seed user groups. An exemplary threshold may be based on time, including monitoring the time before activation occurs. Changes to seed users and/or seed user groups may include selecting seed users to add to the spread that may enhance content item spread.

By way of example, the monitoring platform 209 includes one or more components for monitoring and regulating content item spread process after launching media distribution. It is contemplated that the functions of these components may be combined in one or more components or performed by other components of equivalent functionality. In this embodiment, the monitoring platform 209 includes a controller 321, kernel module 323, length module 325, activation module 327, and update module 329. The controller 321 may, for instance, receive information from the seed user platform 203, the simulation platform 205, and the adopter platform 207.

In one embodiment, the controller 321 may work with the kernel module 323 to determine one or more nodes, within one or more seed user groups to monitor. The controller 321 and the kernel module 323 may use approaches including, for example, webpage ranking schemes in search engines. For instance, a page-rank-like method could be used to scale the importance or significance of each node in a predictive spread track. From this scaling, the controller 321 could select nodes with high significance as kernel nodes. The monitoring platform 209 may identify the kernel nodes prior to launch of media distribution. In one embodiment, the monitoring platform 209 may then monitor only the kernel nodes. In such an embodiment, other nodes may be ignored whether or not they are activated such that their activation does not play into the spread result observed by the monitoring platform 209.

In one embodiment, the controller 321 and length module 325 may determine thresholds to determine when to initiate regulating the spread process. In one embodiment, length module 325 may determine the thresholds in terms of the length of each step or process of sharing from one node to the next, before a given node is activated. In other words, the thresholds may involve whether and when a node could be activated based on the previously discussed graph theory. For example, the graph theory approach may be used to calculate the longest length of spread between nodes. Alternately, the approach may be used to calculate the average length of spread between nodes. In other words, the controller 301 and threshold module 305 may set a threshold for each step between nodes, based on the average time given by historic spread. The time interval of sharing may involve time decay, impairing influence. For example, the potential influence of a node generally decreases as time goes on because it is assumed that the node has already tried to exercise its influence. One possible case of this type of monitoring may include the controller 301 and threshold module 305 calculating that it takes five steps from a starting node, to a given node and assume that thirty minutes is equivalent for one step. Then, if a node is not activated even after 2.5 hours, the controller 321 may initiate some remedy to improve the spread.

In one embodiment, the controller 321 and activation module 327 work to determine whether the kernel nodes are activated within the threshold lengths. If the controller 321 and activation module 327 determine that the kernel nodes are activated past the threshold lengths, the controller 321 may engage the update module 329 to initiate changes to the seed user grouping. In one embodiment, the controller 321 and update module 320 may engage the seed user platform 203 to add more seed users to the seed user group. In one embodiment, the controller 321 and update module 329 may determine that many nodes have already been activated, so the initial pre-launch seed user selection may no longer be relevant. In one embodiment involving offline social networks, the controller 321 and update module 329 may return to the initial pre-launch seed user selection analysis by modifying the social network. For example, the controller 321 may preserve some of the most recently activated nodes as seed users because they may still have the potential to influence their neighbors (whereas long-activated nodes may have already exerted most, if not all, of their influence). In one embodiment, the controller 321 may disregard the long-activated nodes under the assumption that the influence those nodes represent, has already been exhausted. In one embodiment, the controller 321 may then obtain a sub-graph of the whole social network with some of the initial seed users and, using the sub-graph, run the same algorithm or simulation to select seed users in an offline social network.

In one embodiment, the controller 321 and update module 329 may determine new seed users and/or seed user groups in response to activation of unexpected users. Alternately in offline settings, the controller 321 and update module 329 may also respond to emerging implicit social links. While these scenarios both represent positive spread effects, they also are instances where the distribution processor 107 may revisit potential adopter predictions to revise, at least in part, content item distribution, seed user selection, and/or seed user grouping.

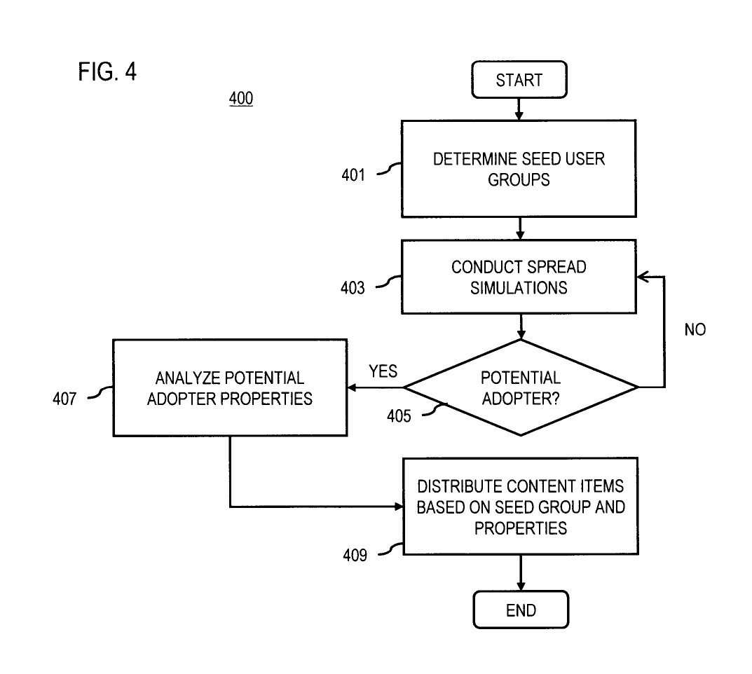

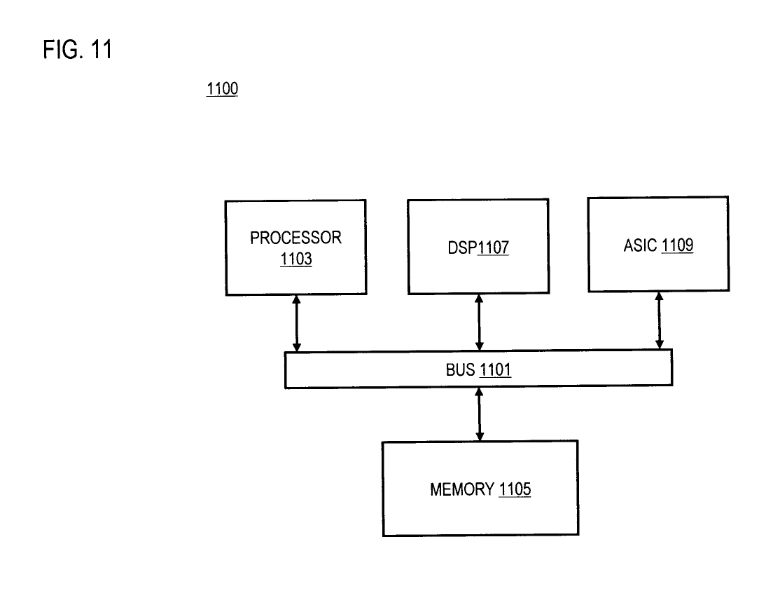

FIG. 4 is a flowchart of a process for distributing media based on spread simulations, according to one embodiment. In one embodiment, the distribution processor 107 performs the process 400 and is implemented in, for instance, a chip set including a processor and a memory as shown in FIG. 11. In step 401, the distribution processor 107 may determine one or more seed user groups made of one or more seed users. In one embodiment, each seed user, may have, at least in part, two properties: a user profile and user preference. Then, for a given content item, the distribution processor 107 may process and/or facilitate a processing of one or more spread process simulations with one or more seed user groups (step 403). In other words, the distribution processor 107 may observe the spread of the given content item through the seed user groups. As previously discussed, Random Walk is one possible approach for distribution processor 107 for conducting spread process simulations. Based on the spread process simulations, the distribution processor 107 may determine one or more potential adopters (step 405). In one embodiment, potential adopters are users that not only view, but share, content items. The distribution processor 107 may then determine a selection of one or more contents for media distribution based, at least in part, on the one or more properties associated with the potential adopters (steps 407 and 409).

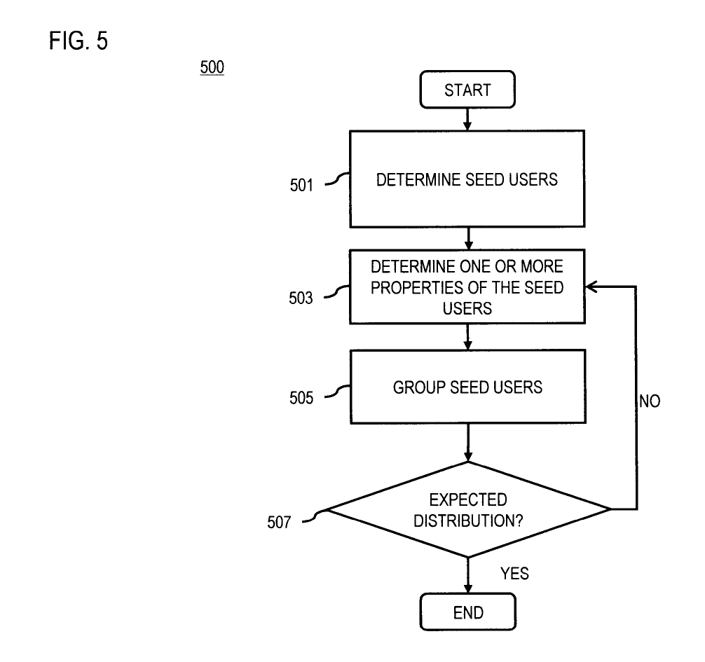

FIG. 5 is a flowchart of a process for determining seed user groups, according to one embodiment. In one embodiment, the distribution processor 107 performs the process 500 and is implemented in, for instance, a chip set including a processor and a memory as shown in FIG. 11. In step 501, the distribution processor 107 may determine one or more seed users. In one embodiment, the one or more seed users may be found from social networking services. In step 503, the distribution processor 107 may process and/or facilitate a processing of one or more properties associated with one or more seed users to form the one or more seed user groups, wherein properties include user profile information, user preference information, or a combination thereof. To do so, the distribution processor 107 may interact with profile platforms 103 to identify similarities between seed users. For users with sufficient similarity, the distribution processor 107 may group the seed users together into one or more seed user groups (step 505). In one embodiment, the distribution processor 107 may determine one or more seed user groups associated with one or more external parameters, wherein external parameters may include time of day, activity, content item, or a combination thereof. For example, a set of seed users may be more likely to view or download media during the day. For instance, students tend to access various media content items during the day, relative to working professionals. If the distribution processor 107 is using “daytime” as a “time of day” parameter and “media access” as an “activity” parameter, the distribution processor 107 may construct one or more seed user groups including students as distinct from one or more seed user groups including professionals.

In another embodiment, the one or more seed user groups are based, at least in part, on network settings, including online, offline, or a combination thereof. As previously discussed, simulation groups, monitoring, and/or updating seed user and kernel user selections may include taking into consideration whether various users are online, offline, or a combination thereof. As such, the one or more seed user groups are predefined, dynamic, or a combination thereof. In one embodiment, as discussed, the distribution processor 107 may determine one or more seed user groups initially for conducting spread process simulations, select one or more seed users and/or one or more seed user groups for actual launch of distributing the content items, and then update the seed user groups in response to the outcome of distribution processor 107 monitoring. In this way, the seed user groups are predefined, dynamic, or a combination thereof.

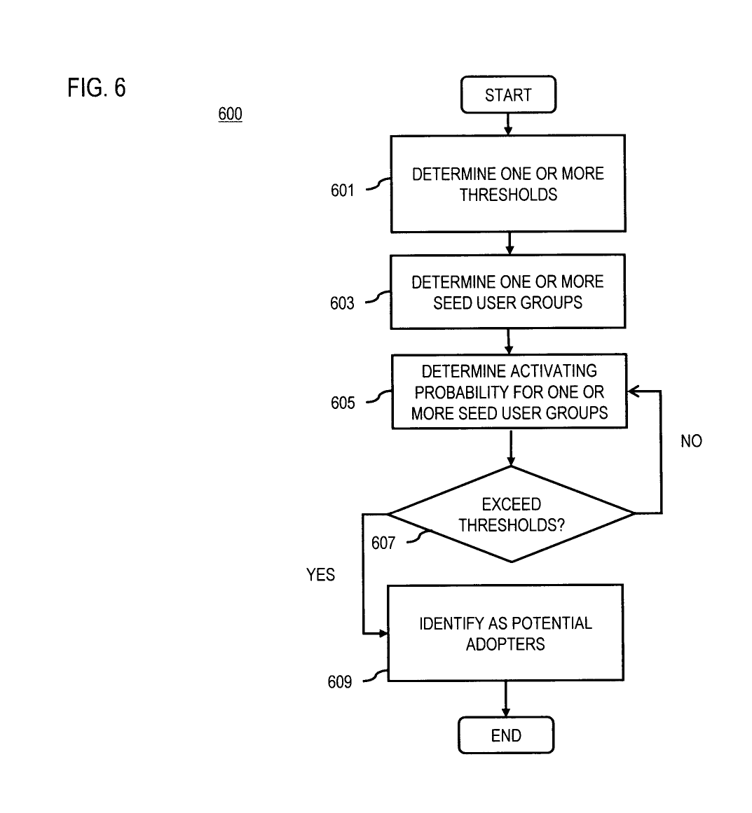

FIG. 6 is a flowchart of a process for conducting spread simulations, according to one embodiment. In one embodiment, the distribution processor 107 performs the process 600 and is implemented in, for instance, a chip set including a processor and a memory as shown in FIG. 11. In one embodiment, the distribution processor 107 may determine one or more thresholds. For example, the thresholds may be thresholds of activating probability with respect to one or more seed users sharing the given content item (step 601). As previously discussed, the distribution processor 107 may then process and/or facilitate a processing of the one or more process simulations to determine activating probability associated with one or more seed users and cause, at least in part, an organization of one or more seed users based, at least in part, on the activating probability (steps 603-605). In doing so, the distribution processor 107 may primarily aim to determine one or more seed users with activating probability exceeding the one or more thresholds (steps 607). As previously discussed, various approaches may be appropriate to simulate the spread process of a given content item through the network of the seed user groups. Consequently, the distribution processor 107 may take the seed users with activating probability exceeding the one or more thresholds as the potential adopters of the content item. In one embodiment, organization of one or more seed users and identification of potential adopters may permit the distribution processor 107 to analyze the properties of the adopters to determine content to distribute, determine new groupings of seed users, select kernel users, etc.

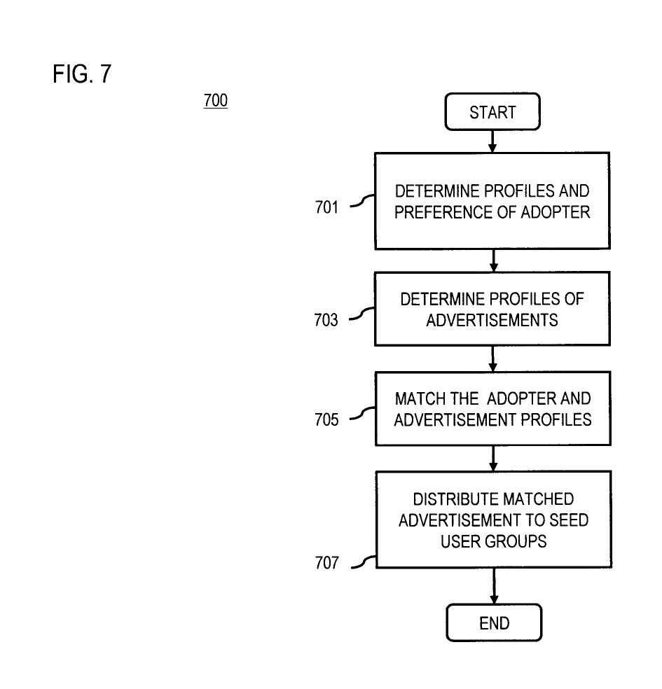

FIG. 7 is a flowchart of a process for interring potential adopters, according to one embodiment. In one embodiment, the distribution processor 107 performs the process 700 and is implemented in, for instance, a chip set including a processor and a memory as shown in FIG. 11. In step 701, the distribution processor 107 may process and/or facilitate a processing of the one or more properties associated with the one or more seed users with activating probability exceeding the one or more thresholds, and cause, at least in part, formation of one or more seed user groups based, at least in part, on the one or more properties associated with one or more seed users with activating probability exceeding the one or more thresholds. Upon determining the one or more properties of the seed users, the distribution processor 107 may determine a selection of one or more content items for media distribution based, at least in part, one the one or more properties associated with the one or more seed users with activating probability exceeding the one or more thresholds (step 703 and 705). In one embodiment, the distribution processor 107 may further cause, at least in part, the one or more content items to be associated with one or more other content items for media distribution, wherein the one or more content items include advertisements. Finally, the distribution processor 107 may distribute the selected content items and other content items to the seed users.

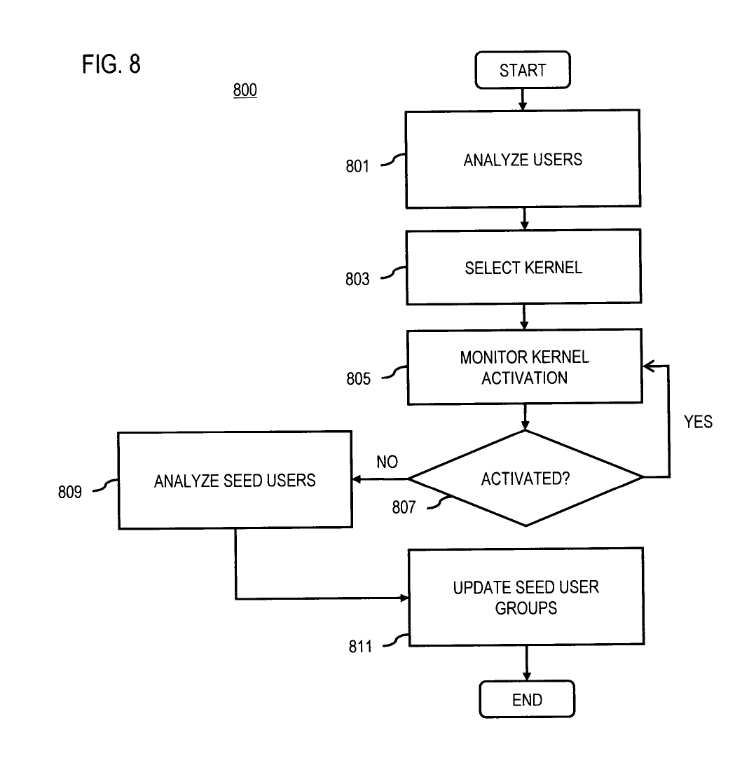

FIG. 8 is a flowchart of a process for monitoring and regulating the media distribution, according to one embodiment. In one embodiment, the distribution processor 107 performs the process 800 and is implemented in, for instance, a chip set including a processor and a memory as shown in FIG. 11. In step 801, the distribution processor 107 may analyze the seed users to determine one or more kernel nodes (step 801 and 803). As previously discussed, selecting kernel nodes may include scaling the importance of each node and selecting nodes with high significance. After launching media distribution, the distribution processor 107 may process and/or facilitate a processing of the media distribution (step 805). As discussed, such processing may include determining whether the one or more kernel nodes are activated within a threshold time (step 807). Where the one or more kernel nodes are not activated within the threshold, the distribution processor 107 may infer that the distribution did not follow the simulation and seek to cause, at least in part, one or more modifications to the one or more seed user groups based, at least in part, on the processing (steps 809 and 811).

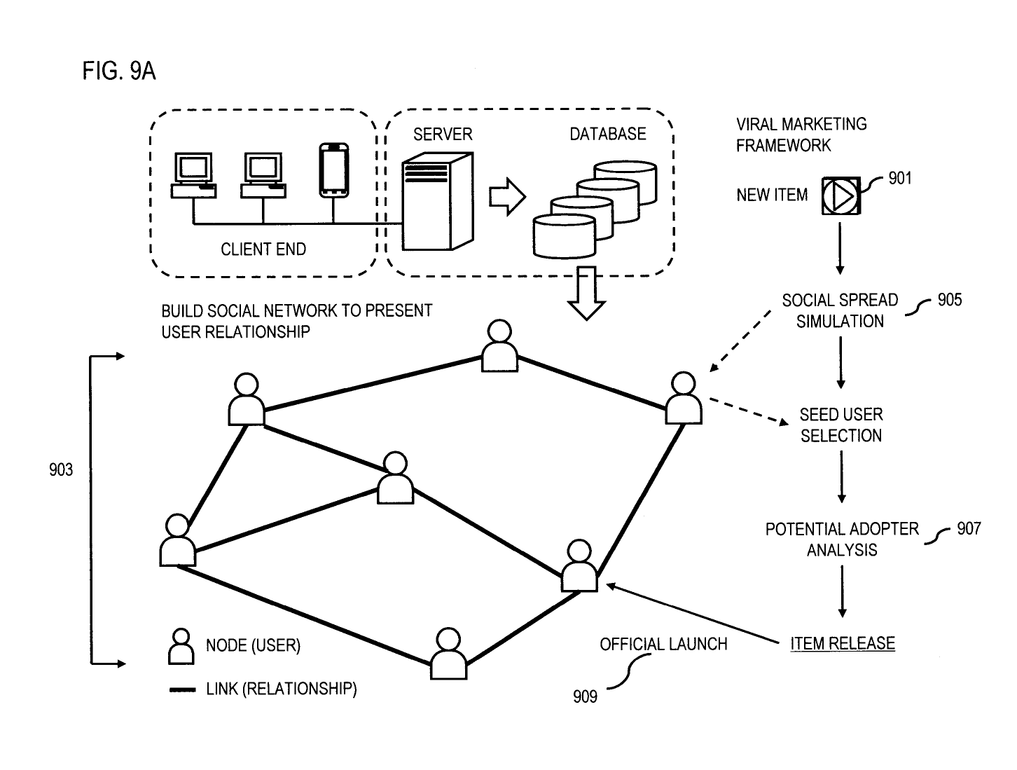

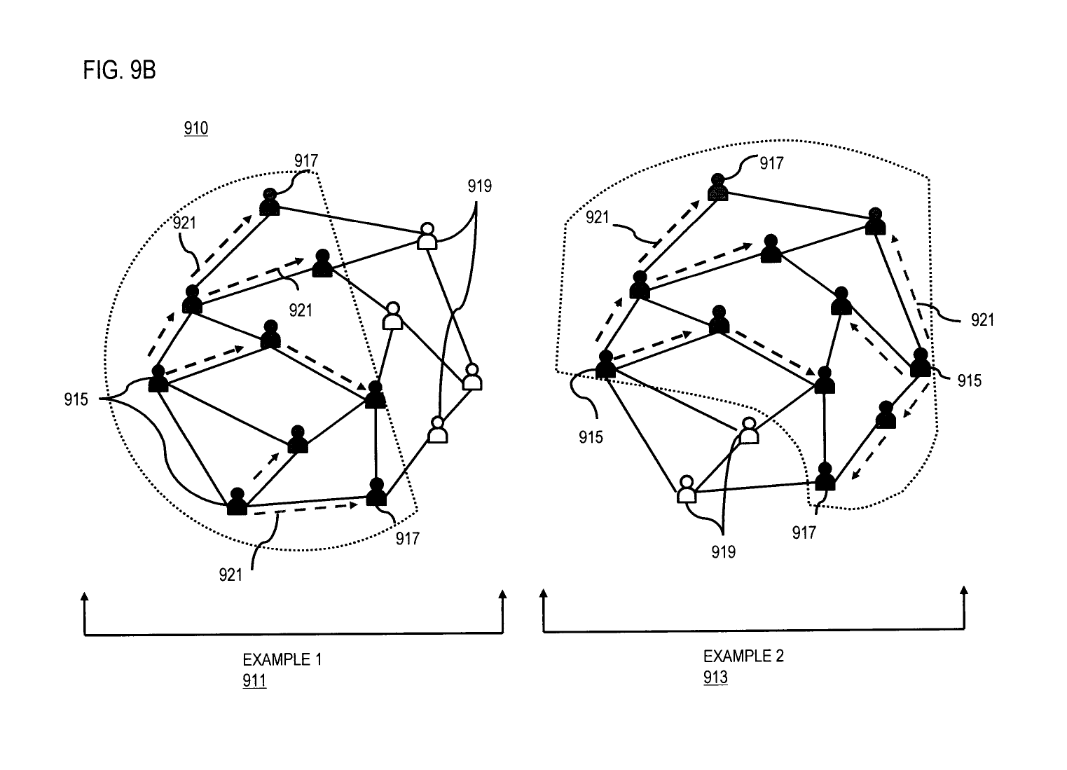

FIGS. 9A-9B are illustrations of the processes of FIG. 4, according to various embodiments. FIG. 9A shows one embodiment where a given content item 901 is selected and system 100 runs a social spread simulation simulating the spread of the content item 901 through seed user group, network 903. In one embodiment, system 100 determines one or more networks 903 and runs the social spread simulation 905 through each of the networks 903. From the simulations 905, the system 100 can determine potential adopters. Conducting potential adopter analysis 907 may involve analyzing properties associated with the potential adopters to determine one or more content items and/or associate one or more other content items to the one or more content items for launch 909 of the items to one or more determined networks 903. After launch 909, the system 100 may continue to monitor networks 903 to see whether spread resembled simulation 905, and whether to update the networks 903.

In FIG. 9B, the distribution processor 107 may determine one or more spread process simulations. The illustration includes two seed user groups, 911 and 913. The distribution processor 107 may run a spread process simulation through each of the seed user groups 911 and 913. The black nodes 915 may be seed users, gray nodes 917 activated nodes, and pale grey nodes 919, inactivated. The dotted line 921 may represent mutual influence from the various seed users 915. For seed user group 911, seven neighboring nodes are activated, leaving four inactivated nodes 919. Seed user group 913, however, activates nine nodes 917 with only two inactivated nodes 919. Between the two seed user groups 911 and 913, the distribution processor 107 may choose the seed user group 913 for further user property analysis to determine content items to distribute.

The processes described herein for using spread simulations to enhance media distribution may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

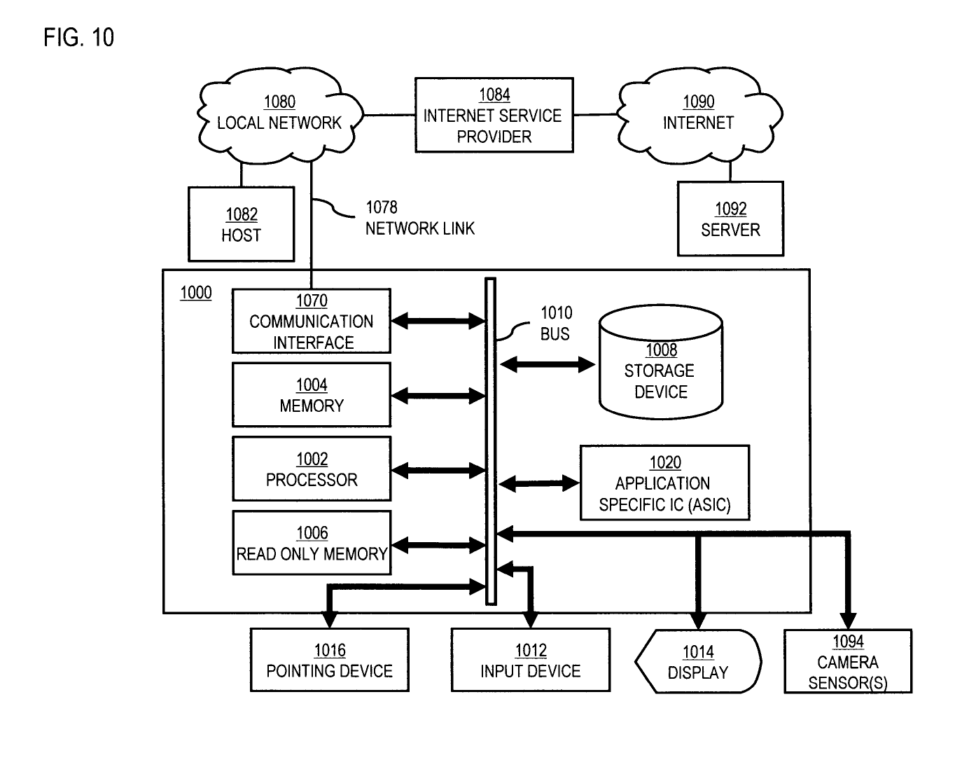

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to use spread simulations to enhance media distribution as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of using spread simulations to enhance media distribution.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to using spread simulations to enhance media distribution. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1000 also includes a memory 1004 coupled to bus 1010. The memory 1004, such as a random access memory (RAM) or any other dynamic storage device, stores information including processor instructions for using spread simulations to enhance media distribution. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for using spread simulations to enhance media distribution, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014, and one or more camera sensors 1094 for capturing, recording and causing to store one or more still and/or moving images (e.g., videos, movies, etc.) which also may comprise audio recordings. In some embodiments, for example, in embodiments in which the computer system 1000 performs all functions automatically without human input, one or more of external input device 1012, display device 1014 and pointing device 1016 may be omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for using spread simulations to enhance media distribution to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to use spread simulations to enhance media distribution as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of using spread simulations to enhance media distribution.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to use spread simulations to enhance media distribution. The memory 1105 also stores the data associated with or generated by the execution of the inventive steps.

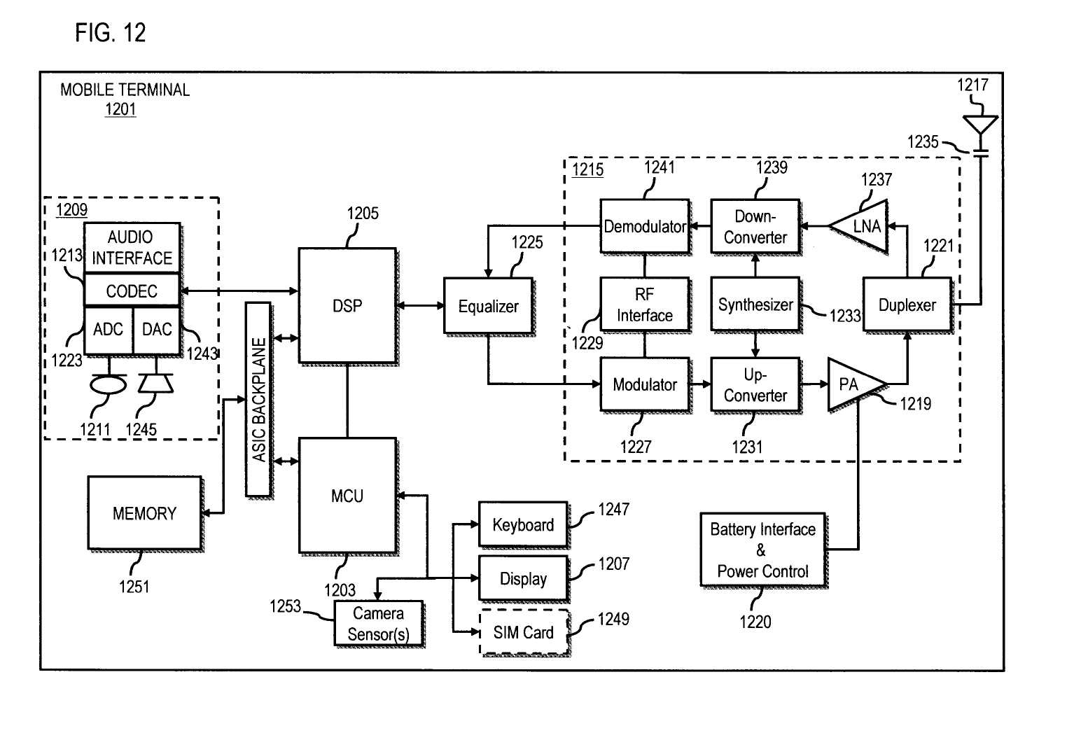

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of using spread simulations to enhance media distribution. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of using spread simulations to enhance media distribution. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to use spread simulations to enhance media distribution. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

Further, one or more camera sensors 1253 may be incorporated onto the mobile station 1201 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising:
determining one or more seed user groups of one or more seed users;
processing and/or facilitating a processing of one or more spread simulations with the one or more seed user groups; and
causing, at least in part, a media distribution based, at least in part, on the one or more spread process simulations.

40. A method of claim 39, further comprising:
processing and/or facilitating a processing of one or more properties associated the with one or more seed users to form the one or more seed user groups,
wherein the one or more properties include, at least in part, user profile information, user preference information, or a combination thereof.

41. A method of claim 40, further comprising:
processing and/or facilitating a processing of the one or more spread process simulations to determine an activating probability associated with the one or more seed users; and
causing, at least in part, an organization of the one or more seed users based, at least in part, on the activating probability.

42. A method of claim 41, further comprising:
determining one or more seed users with the activating probability exceeding one or more thresholds;
processing and/or facilitating a processing of the one or more properties associated with the one or more seed users with the activating probability exceeding the one or more thresholds; and
causing, at least in part, a formation of the one or more seed user groups based, at least in part, on the one or more properties associated with the one or more seed users with the activating probability exceeding the one or more thresholds.

43. A method of claim 39, further comprising:
determining a selection of one or more content items for the media distribution based, at least in part, on the one or more properties associated with the one or more seed users with the activating probability exceeding the one or more thresholds.

44. A method of claim 39, further comprising:
causing, at least in part, an association of the one or more content items with one or more other content items for the media distribution.

45. A method of claim 39, further comprising:
determining the one or more seed user groups associated with one or more external parameters,
wherein the one or more external parameters include, at least in part, a time of day, an activity, a content item, or a combination thereof.

46. A method of claim 39, further comprising:
causing, at least in part, one or more modifications to the one or more seed user groups based, at least in part on a processing of the media distribution.

47. A method of claim 39, wherein the one or more seed user groups are based, at least in part, on one or more network settings, and wherein the one or more network settings include, at least in part, an online status and an offline status.

48. An apparatus comprising:
at least one processor; and
at least one memory including computer program code for one or more programs,
the at least one memory and the computer program code configured to, with the at least one processor, cause the apparatus to perform at least the following,
determine one or more seed user groups of one or more seed users;
process and/or facilitate a processing of one or more spread simulations with the one or more seed user groups; and
causing, at least in part, a media distribution based, at least in part, on the one or more spread process simulations.

49. An apparatus of claim 48, wherein the apparatus is further caused to:
process and/or facilitate a processing of one or more properties associated with the one or more seed users to form the one or more seed user groups,
wherein the one or more properties include, at least in part, user profile information, user preference information, or a combination thereof.

50. An apparatus of claim 49, wherein the apparatus is further caused to:
process and/or facilitate a processing of the one or more spread process simulations to determine an activating probability associated with the one or more seed users; and
cause, at least in part, an organization of the one or more seed users based, at least in part, on the activating probability.

51. An apparatus of claim 50, wherein the apparatus is further caused to:
determine the one or more seed users with the activating probability exceeding one or more thresholds;
process and/or facilitate a processing of the one or more properties associated with the one or more seed users with the activating probability exceeding the one or more thresholds; and
cause, at least in part, a formation of the one or more seed user groups based, at least in part, on the one or more properties associated with the one or more seed users with the activating probability exceeding the one or more thresholds.

52. An apparatus of any of claim 48, wherein the apparatus is further caused to:
determine a selection of one or more content items for the media distribution based, at least in part, on the one or more properties associated with the one or more seed users with the activating probability exceeding the one or more thresholds.

53. An apparatus of any of claim 48, wherein the apparatus is further caused to:
cause, at least in part, an association of the one or more content items with one or more other content items for the media distribution.

54. An apparatus of any of claim 48, wherein the apparatus is further caused to:
determine one or more seed user groups associated with one or more external parameters,
wherein the one or more external parameters may include, at least in part, a time of day, an activity, a content item, or a combination thereof.

55. An apparatus of any of claim 48, wherein the apparatus is further caused to:
causing, at least in part, one or more modifications to the one or more seed user groups based, at least in part on a processing of the media distribution.

56. An apparatus of any of claim 48, wherein the one or more seed user groups are based, at least in part, on one or more network settings, and wherein the one or more network settings include, at least in part, an online status and an offline status.

57. An apparatus of any of claim 48, wherein the one or more seed user groups are predefined, dynamic, or a combination thereof.

58. A non-transitory computer-readable storage medium carrying one or more sequences of one or more instructions which, when executed by one or more processors, cause an apparatus to at least perform:
determining one or more seed user groups of one or more seed users;
processing and/or facilitating a processing of one or more spread simulations with the one or more seed user groups; and
causing, at least in part, a media distribution based, at least in part, on the one or more spread process simulations.
